(19) United States
(12) Patent Application Publication
(10) Pub. No.: US 2024/0331920 A1
(43) Pub. Date: Oct. 3, 2024

(54) INDUCTOR AND DC-DC CONVERTER

(71) Applicant: TDK Corporation, Tokyo (JP)

(72) Inventors: Tomofumi KURODA, Tokyo (JP); Seiko KOMATSU, Tokyo (JP); Hironari GOSHIMA, Tokyo (JP)

(73) Assignee: TDK Corporation, Tokyo (JP)

(21) Appl. No.: 18/620,006

(22) Filed: Mar. 28, 2024

(30) Foreign Application Priority Data
Mar. 30, 2023 (JP) 2023-056245

(51) Int. Cl. H01F 27/26; H01F 27/32; H02M 3/00

(52) U.S. Cl. CPC H01F 27/263; H01F 27/324; H02M 3/003

(57) ABSTRACT

An inductor includes a first magnetic block and a second magnetic block, the first magnetic block and the second magnetic block being disposed to face each other while being separated from each other in a first direction, a coil conductor having a first conductor portion extending in a second direction, in which the first conductor portion is disposed between the first magnetic block and the second magnetic block, the first conductor portion has a first facing surface facing the first magnetic block and a second facing surface facing the second magnetic block, a first insulator is disposed between the first facing surface and the first magnetic block and between the second facing surface and the second magnetic block, and a magnetic material disposed between the first magnetic block and the second magnetic block in a region where the coil conductor and the insulator are not disposed is provided.

### CROSS REFERENCE TO RELATED APPLICATIONS

This application claims priority to Japanese Patent Application No. 2023-056245 filed on Mar. 30, 2023, the entire contents of which are incorporated by reference herein.

### TECHNICAL FIELD

The present disclosure relates to an inductor and a DC-DC converter.

### BACKGROUND

Conventionally, an inductor including a pair of magnetic blocks called EI cores and a coil conductor disposed between the pair of magnetic blocks is known (for example, Japanese Unexamined Patent Publication No. 2000-068129). The pair of magnetic blocks are bonded to each other with an adhesive or the like. In the coil conductor, an insulating film is disposed on a surface facing each magnetic block.

### SUMMARY

According to one aspect of the present disclosure, there is provided an inductor including: a first magnetic block and a second magnetic block each having a rectangular parallelepiped shape, the first magnetic block and the second magnetic block being disposed to face each other while being separated from each other in a first direction; and a coil conductor having a first conductor portion extending in a second direction orthogonal to the first direction, in which the first conductor portion is disposed between the first magnetic block and the second magnetic block in the first direction, the first conductor portion has a first facing surface facing the first magnetic block and a second facing surface facing the second magnetic block, a first insulator is disposed between the first facing surface and the first magnetic block and between the second facing surface and the second magnetic block, and a magnetic material disposed between the first magnetic block and the second magnetic block in a region where the coil conductor and the insulator are not disposed is provided.

According to one aspect of the present disclosure, there is provided a DC-DC converter including the above-described inductor.

### BRIEF DESCRIPTION OF THE DRAWINGS

FIG. 1 is a perspective view of an electronic component according to the present embodiment;

FIG. 2 is a developed view of an inductor;

FIG. 3 is a cross-sectional view taken along line III-III of FIG. 1;

FIGS. 4A to 4C are enlarged cross-sectional views of a first conductor portion and an insulator;

FIG. 5 is a view illustrating a magnetic block of an inductor according to a modification;

FIG. 6 is a view illustrating an inductor according to a modification;

FIG. 7 is a view illustrating an inductor according to a modification; and

FIG. 8 is a diagram illustrating a circuit of a DC-DC converter using the inductor illustrated in FIG. 1.

### DETAILED DESCRIPTION

Here, in the above-described inductor, it is known that an air gap is formed between the magnetic blocks by shortening the dimension of a middle leg portion of the E core among the magnetic blocks, and saturation characteristics are improved by lowering magnetic permeability. However, in this structure, the thickness of the air gap varies depending on dimensional processing accuracy of the middle leg portion and an outer leg portion of the E core. In addition, since an adhesive is required at the time of joining the pair of magnetic blocks, the thickness of the air gap varies. The large variation of the air gap increases the variation of the inductance.

Therefore, an object of the present disclosure is to provide an inductor and a DC-DC converter that ensure insulation between a coil conductor and a magnetic block while suppressing variation in inductance.

According to one aspect of the present disclosure, it is possible to provide an inductor and a DC-DC converter that ensure insulation between a coil conductor and a magnetic block while suppressing variation in inductance.

Hereinafter, some embodiments of the present disclosure will be described in detail. However, the present disclosure is not limited to the following embodiments.

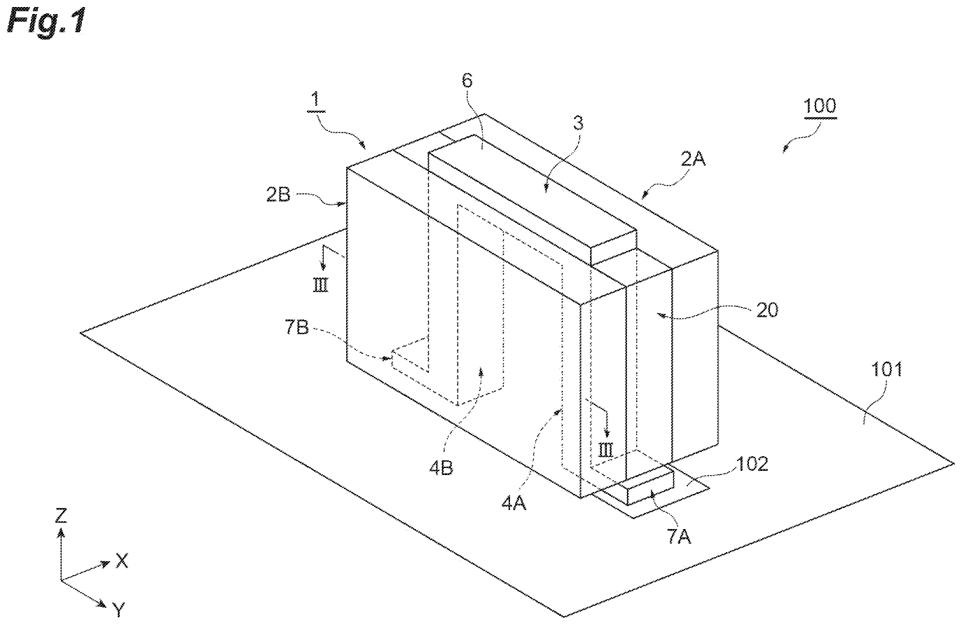

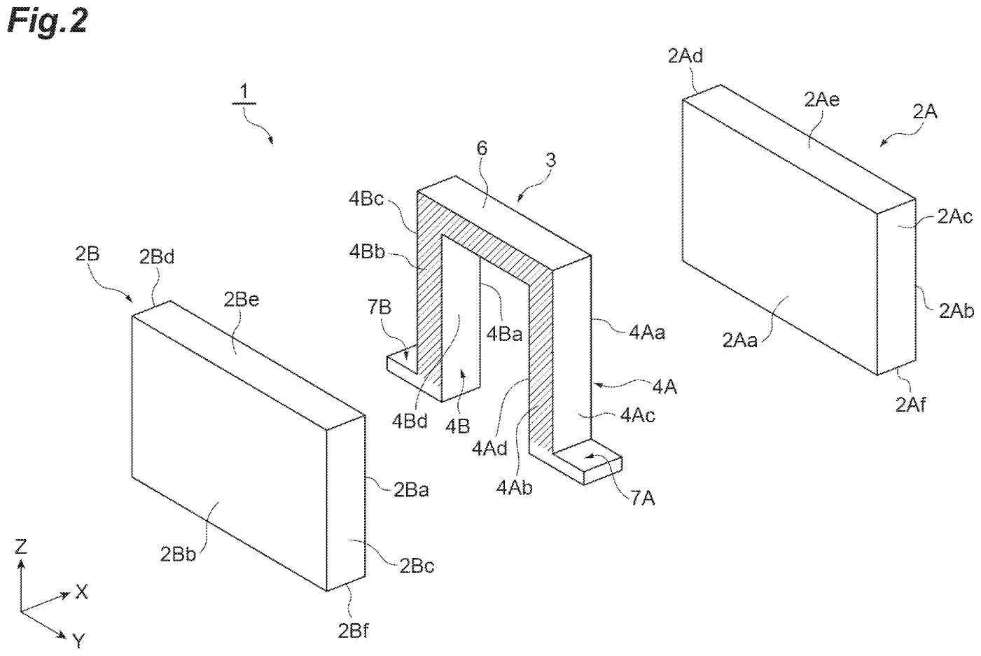

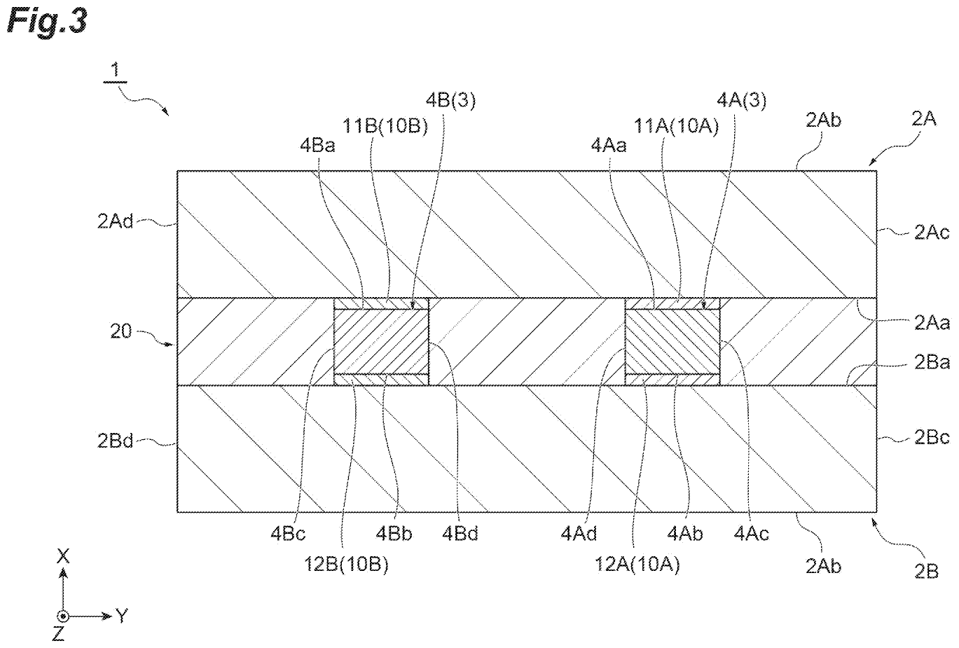

First, a schematic configuration of an inductor 1 according to the present embodiment will be described with reference to FIGS. 1 and 2. FIG. 1 is a perspective view of the inductor 1 according to the present embodiment. FIG. 2 is a developed view of the inductor 1. FIG. 3 is a cross-sectional view taken along line III-III of FIG. 1. The inductor 1 according to the present embodiment is formed by stacking the magnetic blocks 2A and 2B in an X-axis direction. In the present embodiment, the X-axis direction, a Y-axis direction, and a Z-axis direction are orthogonal to each other. The X-axis direction corresponds to a “first direction” in claims, the Z-axis direction orthogonal to the X-axis direction corresponds to a “second direction” in the claims, and the Y-axis direction orthogonal to the X-axis direction and the Z-axis direction corresponds to a “third direction” in the claims.

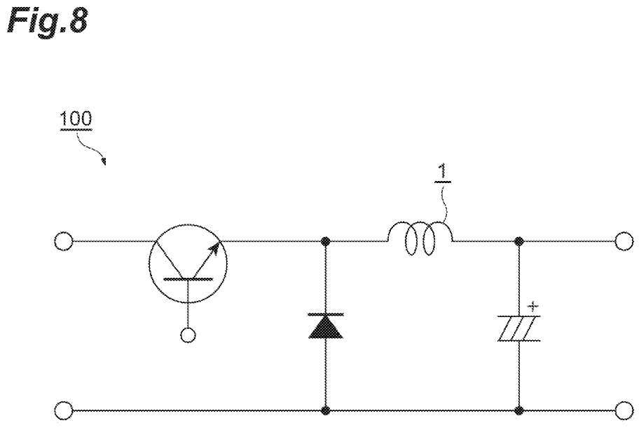

As illustrated in FIG. 1, the inductor 1 includes a first magnetic block 2A, a second magnetic block 2B, and a coil conductor 3. The inductor 1 can be adopted as a choke coil of a circuit of a DC-DC converter 100 illustrated in FIG. 8.

The DC-DC converter 100 includes a pair of input terminals to which a DC input voltage is input, a pair of output terminals, a switching element and a choke coil connected in series to high potential sides of the pair of input terminals, a diode connected between a connection point between a switching element and the choke coil and low potential sides of the pair of input terminals, and a capacitor connected between the pair of output terminals. The DC-DC converter 100 operates as a step-down converter that steps down an input DC voltage by switching on and off of a switching element on the basis of a control signal from a control circuit (not illustrated). Note that the DC-DC converter 100 may be a multiphase converter including a plurality of conversion units including a switching element, a choke coil, and a diode, and the conversion units connected in parallel, and the inductor 1 may be employed as the choke coil of each conversion unit.

The first magnetic block 2A and the second magnetic block 2B are disposed to face each other while being separated from each other in the X-axis direction. The magnetic blocks 2A and 2B have a rectangular parallelepiped shape. In the present embodiment, a rectangular parallelepiped shape that is flat in the X-axis direction is formed. The magnetic blocks 2A and 2B have the same shape. The magnetic blocks 2A and 2B can be made of, for example, a sintered magnetic core such as MnZn-based ferrite or NiZn-based ferrite, or a magnetic material such as a laminated magnetic core formed by laminating soft magnetic metal plates. Magnetic permeability of the magnetic blocks 2A and 2B may be 1000 or more. In addition, the magnetic blocks 2A and 2B may have substantially the same or different magnetic characteristics.

As illustrated in FIG. 2, the first magnetic block 2A includes a facing surface 2Aa (third facing surface), a main surface 2Ab, end surfaces 2Ac and 2Ad, and side surfaces 2Ae and 2Af. The facing surface 2Aa is a surface facing the coil conductor 3 in the X-axis direction. The main surface 2Ab is a surface opposite to the facing surface 2Aa in the X-axis direction. The facing surface 2Aa is disposed on a negative side in the X-axis direction, and the main surface 2Ab is disposed on a positive side in the X-axis direction. The end surfaces 2Ac and 2Ad are surfaces facing each other in the Y-axis direction. The end surface 2Ac is disposed on a positive side in the Y-axis direction, and the end surface 2Ad is disposed on a negative side in the Y-axis direction. The side surfaces 2Ae and 2Af are surfaces facing each other in the Z-axis direction. The side surface 2Ae is disposed on a positive side in the Z-axis direction, and the side surface 2Af is disposed on a negative side in the Z-axis direction.

The second magnetic block 2B has a facing surface 2Ba (fourth facing surface), a main surface 2Bb, end surfaces 2Bc and 2Bd, and side surfaces 2Be and 2Bf. The facing surface 2Ba is a surface facing the coil conductor 3 in the X-axis direction. The main surface 2Bb is a surface opposite to the facing surface 2Ba in the X-axis direction. The facing surface 2Ba is disposed on the positive side in the X-axis direction, and the main surface 2Bb is disposed on the negative side in the X-axis direction. The end surfaces 2Bc and 2Bd are surfaces facing each other in the Y-axis direction. The end surface 2Bc is disposed on the positive side in the Y-axis direction, and the end surface 2Bd is disposed on the negative side in the Y-axis direction. The side surfaces 2Be and 2Bf are surfaces facing each other in the Z-axis direction. The side surface 2Be is disposed on the positive side in the Z-axis direction, and the side surface 2Bf is disposed on the negative side in the Z-axis direction.

As illustrated in FIG. 1, the magnetic blocks 2A and 2B are disposed at the same position in a Y-Z plane such that the end surfaces 2Ac and 2Ad and the side surfaces 2Ae and 2Af overlap with the end surfaces 2Bc and 2Bd and the side surfaces 2Be and 2Bf when viewed from the X-axis direction. Note that a positional deviation within a range caused by a manufacturing error or the like is included in the “same position”.

The coil conductor 3 includes a first conductor portion 4A, a second conductor portion 4B, a coupling portion 6, a first terminal portion 7A, and a second terminal portion 7B. The material of the coil conductor 3 is made of, for example, a metal selected from Cu, Ag, Au, Al, Ni, Sn, and the like.

The conductor portions 4A and 4B extend in the Z-axis direction and are disposed between the first magnetic block 2A and the second magnetic block 2B in the X-axis direction. The first conductor portion 4A is disposed on the positive side in the Y-axis direction, and the second conductor portion 4B is disposed on the negative side in the Y-axis direction. The coupling portion 6 is a member that couples the first conductor portion 4A and the second conductor portion 4B. The coupling portion 6 is connected to end portions of the conductor portions 4A and 4B on the positive side in the Z-axis direction and extends in the Y-axis direction. The first terminal portion 7A is provided at the end portion of the first conductor portion 4A on the negative side in the Z-axis direction and extends toward the positive side in the Y-axis direction. The second terminal portion 7B is provided at the end portion of the second conductor portion 4B on the negative side in the Z-axis direction, and extends to the negative side in the Y-axis direction. The terminal portions 7A and 7B are bonded to an electrode 102 of a substrate 101. As a result, the inductor 1 is mounted on the substrate 101.

As illustrated in FIG. 2, the first conductor portion 4A has a facing surface 4Aa (first facing surface), a facing surface 4Ab (second facing surface), and side surfaces 4Ac and 4Ad. The facing surface 4Aa is a surface facing the first magnetic block 2A in the X-axis direction. The facing surface 4Ab is a surface facing the second magnetic block 2B in the X-axis direction. The facing surface 4Aa is disposed on the positive side in the X-axis direction, and the facing surface 4Ab is disposed on the negative side in the X-axis direction. The side surfaces 4Ac and 4Ad are surfaces facing each other in the Y-axis direction. The side surface 4Ac is disposed on the positive side in the Y-axis direction, and the side surface 4Ad is disposed on the negative side in the Y-axis direction.

The second conductor portion 4B has a facing surface 4Ba (fifth facing surface), a facing surface 4Bb (sixth facing surface), and side surfaces 4Bc and 4Bd. The facing surface 4Ba is a surface facing the first magnetic block 2A in the X-axis direction. The facing surface 4Bb is a surface facing the second magnetic block 2B in the X-axis direction. The facing surface 4Ba is disposed on the positive side in the X-axis direction, and the facing surface 4Bb is disposed on the negative side in the X-axis direction. The side surfaces 4Bc and 4Bd are surfaces facing each other in the Y-axis direction. The side surface 4Bc is disposed on the negative side in the Y-axis direction, and the side surface 4Bd is disposed on the positive side in the Y-axis direction.

The facing surfaces 4Aa and 4Ba and the surfaces of the coupling portion 6 and the terminal portions 7A and 7B on the positive side in the X-axis direction are disposed in the same plane. The facing surfaces 4Ab and 4Bb and the surfaces of the coupling portion 6 and the terminal portions 7A and 7B on the negative side in the X-axis direction are disposed in the same plane. At least a part of the facing surface 4Aa and at least a part of the facing surface 4Ab of the first conductor portion 4A are parallel to the facing surface 2Aa of the first magnetic block 2A with respect to the first conductor portion 4A and the facing surface 2Ba of the second magnetic block 2B with respect to the first conductor portion 4A, respectively. At least a part of the facing surface 4Ba and at least a part of the facing surface 4Bb of the second conductor portion 4B are parallel to the facing surface 2Aa of the first magnetic block 2A with respect to the second conductor portion 4B and the facing surface 2Ba of the second magnetic block 2B with respect to the second conductor portion 4B, respectively.

Next, the cross-sectional shape of the inductor 1 will be described in detail with reference to FIG. 3. As illustrated in FIG. 3, an insulator 10A (first insulator) is disposed between the facing surface 4Aa and the first magnetic block 2A and between the facing surface 4Ab and the second magnetic block 2B. An insulator 10B (second insulator) is disposed between the facing surface 4Ba and the first magnetic block 2A and between the facing surface 4Bb and the second magnetic block 2B.

In the present embodiment, the insulator 10A for the first conductor portion 4A includes an insulating portion 11A formed on the facing surface 4Aa and an insulating portion 12A formed on the facing surface 4Ab. No insulating portion is formed on the side surfaces 4Ac and 4Ad. The insulator 10B for the second conductor portion 4B includes an insulating portion 11B formed on the facing surface 4Ba and an insulating portion 12B formed on the facing surface 4Bb. No insulating portion is formed on the side surfaces 4Bc and 4Bd. In FIG. 2, hatched portions of the coil conductor 3 are portions where the insulators 10A and 10B are disposed. The insulators 10A and 10B are also formed in the same range on the facing surfaces 4Aa and 4Ba side. When the coupling portion 6 is also sandwiched between the magnetic blocks 2A and 2B, an insulator may be formed.

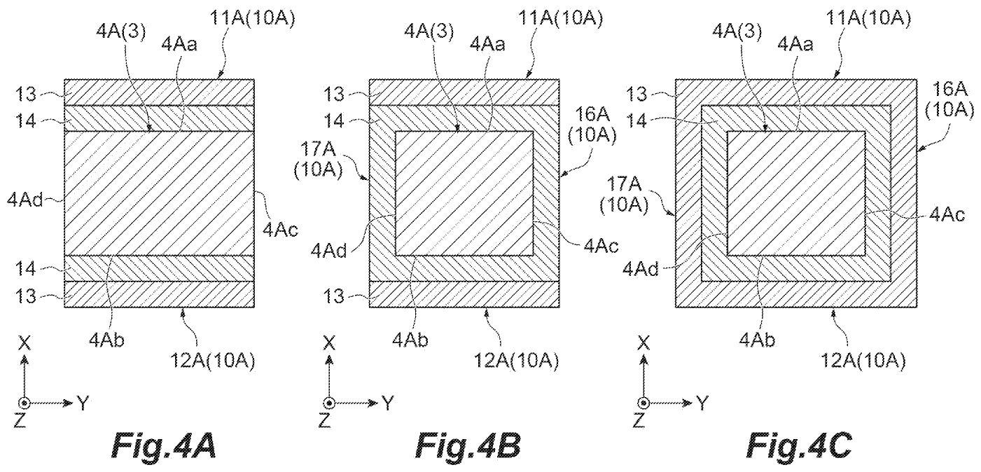

FIG. 4A is a cross-sectional view illustrating the configuration of the insulator 10A in detail. As illustrated in FIG. 4A, the insulating layer 14 and the adhesive layer 13 are disposed in this order from the first conductor portion 4A in the X-axis direction. The insulating layer 14 is a layer that exhibits insulation of the insulator 10A. As the insulating layer 14, polyimide, epoxy, urethane, an insulating tape, ceramic, glass, or the like may be adopted. The adhesive layer 13 may be a resin containing magnetic powder or a magnetic material. The adhesive layer 13 is a layer for adhering to the magnetic blocks 2A and 2B. As the adhesive layer 13, epoxy, acrylic, or the like may be employed.

As illustrated in FIG. 4B, the insulating layer 14 may further include a portion covering the surface (side surfaces 4Ac and 4Ad) of the first conductor portion 4A in the Y-axis direction. The insulator 10A includes an insulating portion 16A formed on the side surface 4Ac of the first conductor portion 4A and an insulating portion 17A formed on the side surface 4Ad. The insulating portions 16A and 17A have an insulating layer 14. As illustrated in FIG. 4C, the insulating portions 16A and 17A may include not only the insulating layer 14 but also the adhesive layer 13.

As illustrated in FIG. 3, a magnetic material 20 disposed between the first magnetic block 2A and the second magnetic block 2B in a region where the coil conductor 3 and the insulators 10A and 10B are not disposed is provided. The magnetic material 20 is disposed so as to be in contact with the facing surface 2Aa of the first magnetic block 2A, the facing surface 2Ba of the second magnetic block 2B, the side surfaces 4Ac and 4Ad of the first conductor portion 4A, the side surfaces 4Bc and 4Bd of the second conductor portion 4B, and the side surfaces of the insulators 10A and 10B. When viewed from the X-axis direction, the end surfaces on both sides in the Y-axis direction of the magnetic material 20 coincide with the end surfaces 2Ac, 2Bc, 2Ad, and 2Bd, and the side surfaces on both sides in the Z-axis direction of the magnetic material 20 coincide with the side surfaces 2Ae, 2Be, 2Af, and 2Bf.

The magnetic material 20 may have a magnetic permeability of 5 or more, or 20 or more. In this case, even when the coil conductor 3 becomes thicker, a high inductance can be obtained, and the electric resistance of the coil conductor 3 can be further reduced. The magnetic material 20 may have a magnetic permeability of 100 or less, or 50 or less. The magnetic material 20 may have a magnetic permeability lower than that of the magnetic blocks 2A and 2B. The magnetic material 20 is disposed so as to be in contact with the first magnetic block 2A and the second magnetic block 2B. As the magnetic material 20, a mixture of a soft magnetic metal powder and a resin or the like may be adopted. As the soft magnetic metal powder, an iron-silicon alloy, permalloy, sendust, amorphous, nanocrystalline alloy, or a mixture thereof can be used. As the resin, a thermosetting resin such as epoxy can be used. The thickness (that is, the distance between the magnetic blocks 2A and 2B) of the magnetic material 20 may be 0.2 to 3.0 mm.

Next, functions and effects of the inductor 1 and the DC-DC converter 100 according to the present embodiment will be described.

The inductor 1 according to the present embodiment includes the first magnetic block 2A and the second magnetic block 2B each having a rectangular parallelepiped shape, which are disposed to face each other while being separated from each other in the X-axis direction, and the coil conductor 3 having the first conductor portion 4A extending in the Z-axis direction. The first conductor portion 4A is disposed between the first magnetic block 2A and the second magnetic block 2B in the X-axis direction, the first conductor portion 4A has the first facing surface 4Aa facing the first magnetic block 2A and the second facing surface 4Ab facing the second magnetic block 2B, the first insulator 10A is disposed between the first facing surface 4Aa and the first magnetic block 2A and between the second facing surface 4Ab and the second magnetic block 2B, and the magnetic material 20 disposed between the first magnetic block 2A and the second magnetic block 2B in the region where the coil conductor 3 and the insulator 10A are not disposed is provided.

In the inductor 1, the first insulator 10A is disposed between the first facing surface 4Aa of the first conductor portion 4A and the first magnetic block 2A and between the second facing surface 4Ab of the first conductor portion 4A and the second magnetic block 2B. Therefore, insulation between the coil conductor 3 and the magnetic blocks 2A and 2B can be secured. In addition, the inductor 1 includes the magnetic material 20 which is disposed between the first magnetic block 2A and the second magnetic block 2B in the region where the coil conductor 3 and the insulator 10A are not disposed. Since the magnetic blocks 2A and 2B are filled with the magnetic material as described above, the occurrence of an air gap in the magnetic path of the inductor 1 is suppressed. Since the occurrence of the air gap is suppressed, the variation in inductance caused by the variation in the size of the air gap can be reduced. As described above, it is possible to ensure insulation between the coil conductor and the magnetic block while suppressing variation in inductance.

Here, the inductance of the inductor 1 is inversely proportional to the magnetic resistance. The magnetic resistance is inversely proportional to magnetic permeability (u) and proportional to a magnetic path length (Le). That is, the overall magnetic resistance proportional to “Le/μ” can be approximated by the sum of the magnetic resistance of the pair of magnetic blocks and the magnetic resistance of the air gap. As a comparative example, a configuration in which an air gap exists between a pair of magnetic blocks will be examined. For example, it is assumed that the magnetic block has a magnetic permeability of 2000 or more and the air gap has a magnetic permeability of 1. At this time, for example, assuming that the magnetic path length of the magnetic block is 10 mm, when the magnetic path length of the air gap increases from 10 μm to 20 μm, the magnetic resistance changes by 67%.

Meanwhile, according to the configuration of the inductor 1 as in the present embodiment, it is assumed that the magnetic block has a magnetic permeability of 2000 or more and the magnetic material 20 has a magnetic permeability of 20. For example, when the magnetic path length of the magnetic blocks 2A and 2B is 10 mm and the magnetic path length of the magnetic material 20 is 200 μm, the magnetic resistance is equivalent to an air gap of 10 μm. For example, when the magnetic path length of the magnetic material 20 increases from 200 μm to 210 μm, the magnetic resistance changes only by 3%. As described above, even when the thickness of the magnetic material 20 slightly changes due to the variation of each component of the inductor 1, the variation in inductance can be suppressed. In addition, by disposing the magnetic block, the coil conductor 3, and the insulators 10A and 10B as in the present embodiment, the distance between the pair of magnetic blocks, that is, the thickness dimension of the magnetic material 20 can be defined by the dimensions of the coil conductor 3 and the insulators 10A and 10B. Since the thicknesses of the insulators 10A and 10B are sufficiently smaller than the thickness of the coil conductor 3, it is easy to control variations in the dimension of the magnetic material 20 only by controlling the thickness of the coil conductor 3.

The magnetic material 20 is disposed so as to be in contact with the first magnetic block 2A and the second magnetic block 2B. In this case, generation of an air gap between the magnetic material 20 and the magnetic blocks 2A and 2B can be suppressed, and variation in inductance can be suppressed. In the present embodiment, the magnetic material 20 is disposed on the entire surface of a region where the coil conductor 3 and the insulators 10A and 10B are not disposed in the magnetic blocks 2A and 2B. However, as in a case where the side surfaces of the magnetic material 20 facing each other in the Z-axis direction or the end surfaces facing each other in the Y-axis direction do not coincide with the end surfaces or the side surfaces of the magnetic blocks 2A and 2B, the magnetic material may not be disposed on the entire surface of the region of the magnetic blocks 2A and 2B where the coil conductor 3 or the insulators 10A and 10B are not disposed. In this case, the magnetic material 20 may be disposed on almost the entire surface (a region occupying half or more of the area) in the region of the magnetic blocks 2A and 2B where the coil conductor 3 and the insulators 10A and 10B are not disposed.

The insulator 10A may include at least an insulating layer 14 and an adhesive layer 13. As a result, the coil conductor 3 can be fixed to the magnetic blocks 2A and 2B while reliably securing insulation by the insulating layer 14.

At least a part of the first facing surface 4Aa of the first conductor portion 4A may be parallel to the facing surface 2Aa of the first magnetic block 2A with respect to the first conductor portion 4A. At least a part of the second facing surface 4Ab of the first conductor portion 4A may be parallel to the facing surface 2Ba of the second magnetic block 2B with respect to the first conductor portion 4A. In this case, it is possible to suppress generation of an air gap between the first conductor portion 4A and the magnetic blocks 2A and 2B.

In the X-axis direction, the insulating layer 14 and the adhesive layer 13 may be disposed in this order from the first conductor portion 4A. In this case, the coil conductor 3 can be fixed to the magnetic blocks 2A and 2B in the magnetic blocks 2A and 2B while reliably securing insulation by the insulating layer 14 on the first conductor portion 4A side.

The insulating layer 14 may further include a portion covering the surface of the first conductor portion 4A in the Y-axis direction. In this case, the insulation can be further ensured.

The magnetic material 20 may have a magnetic permeability of 5 or more. In this case, even when the coil conductor 3 becomes thick, a high inductor can be obtained, and the electric resistance of the coil conductor 3 can be reduced.

The coil conductor 3 may further include the second conductor portion 4B extending in the Z-axis direction and disposed between the first magnetic block 2A and the second magnetic block 2B, and the coupling portion 6 coupling the first conductor portion 4A and the second conductor portion 4B, and the second conductor portion 4B may have the facing surface 4Ba facing the first magnetic block 2A and the facing surface 4Bb facing the second magnetic block 2B, and the second insulator 10B may be disposed between the facing surface 4Ba and the first magnetic block 2A and between the facing surface 4Bb and the second magnetic block 2B. By providing the second conductor portion in this manner, it is possible to suppress variation in inductance in a case where there are a plurality of conductor portions.

The DC-DC converter 100 according to the present embodiment includes the inductor described above.

According to the DC-DC converter 100, since the variation in the inductance of the inductor 1 is small, it is possible to obtain a DC-DC converter in which the variation in the output waveform is small.

The present disclosure is not limited to the above-described embodiments.

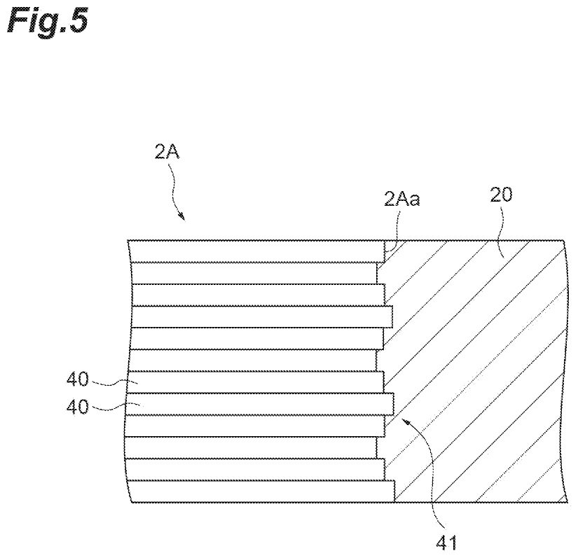

As illustrated in FIG. 5, each of the first magnetic block 2A and the second magnetic block 2B may be configured by laminating a plurality of soft magnetic metal plates 40. As the soft magnetic metal plate 40, a magnetic ribbon such as an amorphous alloy or an Fe-based nanocrystal alloy can be used. In addition, the facing surface 2Aa and the facing surface 2Ba of the first magnetic block 2A and the second magnetic block 2B with respect to the first conductor portion 4A may have uneven portions 41. The facing surface 2Aa of the first magnetic block 2A with respect to the first conductor portion 4A and the fourth facing surface 2Ba of the second magnetic block 2B with respect to the first conductor portion 4A have uneven portions 41. In this case, the magnetic material 20 enters the uneven portion 41, so that adhesion between the magnetic blocks 2A and 2B and the magnetic material 20 can be enhanced, and the structure can be stabilized. In addition, since the uneven portion 41 is filled with the magnetic material 20, the air gap can be reduced, and the variation in inductance can be suppressed.

Note that a case where the magnetic blocks 2A and 2B have uneven portions is also included in the “rectangular parallelepiped shape” in the claims. In addition, the magnetic blocks 2A and 2B are formed in a rectangular parallelepiped shape in consideration of the roughness because the surface has roughness in both the case where the magnetic blocks 2A and 2B are formed of magnetic ribbons and the case where the magnetic blocks 2A and 2B are formed of ferrite. That is, the “rectangular parallelepiped shape” is not limited to a strict rectangular parallelepiped, and includes a rectangular parallelepiped as a whole.

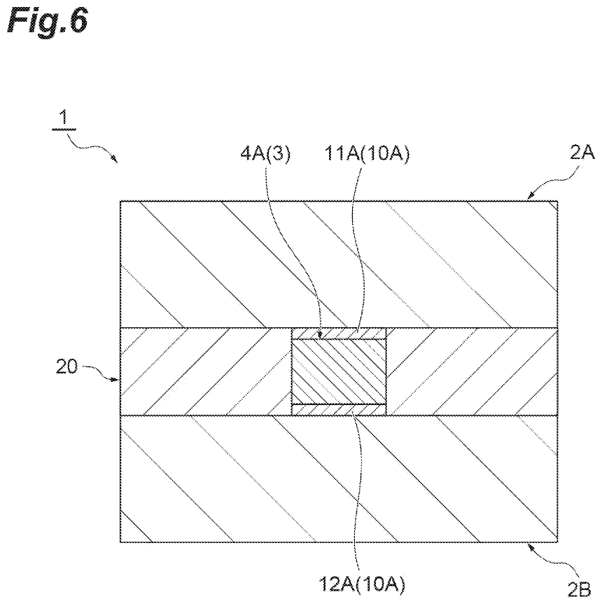

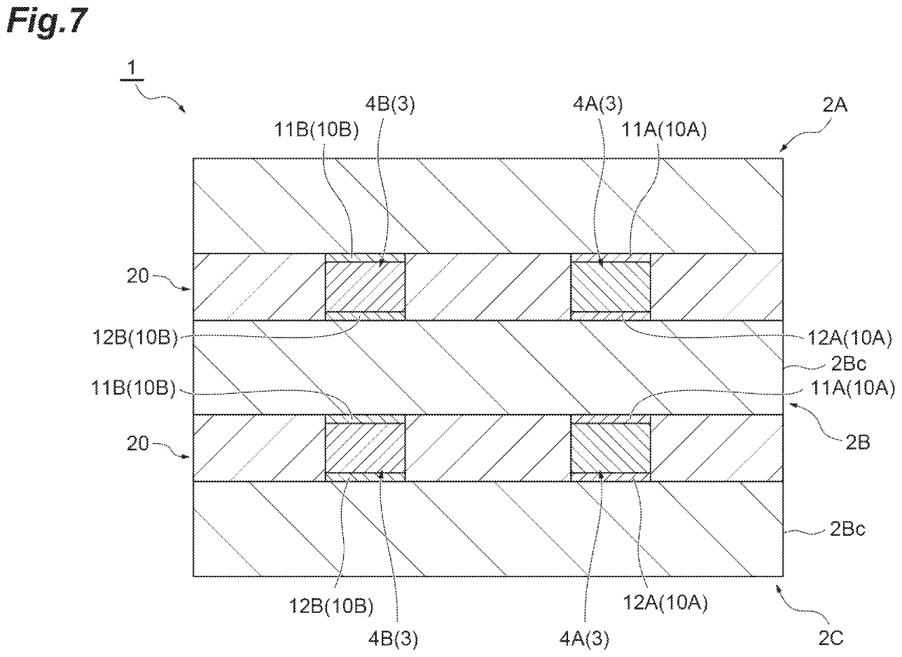

The number of conductor portions is not particularly limited. For example, as illustrated in FIG. 6, only one first conductor portion 4A may be disposed between the magnetic blocks 2A and 2B. In addition, as illustrated in FIG. 7, four conductor portions may be provided by laminating the magnetic blocks 2A, 2B, and 2C and arranging a pair of conductor portions 4A and 4B therebetween. In the example illustrated in FIG. 7, additional conductor portions 4A and 4B are disposed between the magnetic blocks 2B and 2C. In addition, the insulators 10A and 10B of the insulating portions 11A and 11B are disposed between the magnetic block 2B and the conductor portions 4A and 4B. The insulating portions 12A and 12B of the insulators 10A and 10B are disposed between the magnetic block 2C and the conductor portions 4A and 4B. In addition, the inductor 1 includes the magnetic material 20 disposed between the magnetic blocks 2B and 2C in the region where the conductor portions 4A and 4B and the insulators 10A and 10B are not disposed. Note that the inductor 1 illustrated in FIG. 7 can also be used as an inductor in which the choke coils of the respective conversion units of the multiphase converter are integrated.

### [Aspect 1]

An inductor including:
a first magnetic block and a second magnetic block each having a rectangular parallelepiped shape, the first magnetic block and the second magnetic block being disposed to face each other while being separated from each other in a first direction; and
a coil conductor having a first conductor portion extending in a second direction orthogonal to the first direction,
in which the first conductor portion is disposed between the first magnetic block and the second magnetic block in the first direction,
the first conductor portion has a first facing surface facing the first magnetic block and a second facing surface facing the second magnetic block,
a first insulator is disposed between the first facing surface and the first magnetic block and between the second facing surface and the second magnetic block, and
a magnetic material disposed between the first magnetic block and the second magnetic block in a region where the coil conductor and the insulator are not disposed is provided.

### [Aspect 2]

The inductor according to Aspect 1, in which the magnetic material is disposed so as to be in contact with the first magnetic block and the second magnetic block.

### [Aspect 3]

The inductor according to Aspect 1 or 2, in which the insulator includes at least an insulating layer and an adhesive layer.

### [Aspect 4]

The inductor according to any one of Aspects 1 to 3, in which at least a part of the first facing surface of the first conductor portion is parallel to a third facing surface of the first magnetic block with respect to the first conductor portion, and
wherein at least a part of the second facing surface of the first conductor portion is parallel to a fourth facing surface of the second magnetic block with respect to the first conductor portion.

### [Aspect 5]

The inductor according to Aspect 3, in which the first conductor portion, the insulating layer, and the adhesive layer are disposed in this order in the first direction.

### [Aspect 6]

The inductor according to Aspect 3, in which the insulating layer further includes a portion covering a surface of the first conductor portion in a third direction orthogonal to the first direction and the second direction.

### [Aspect 7]

The inductor according to any one of Aspects 1 to 6, in which the magnetic material has a magnetic permeability of 5 or more.

### [Aspect 8]

The inductor according to any one of Aspects 1 to 7, in which the first magnetic block and the second magnetic block are each configured by laminating a plurality of magnetic ribbons, and a third facing surface of the first magnetic block with respect to the first conductor portion and a fourth facing surface of the second magnetic block with respect to the first conductor portion have an uneven portion.

### [Aspect 9]

The inductor according to any one of Aspects 1 to 8, in which the coil conductor further includes
a second conductor portion extending in the second direction and disposed between the first magnetic block and the second magnetic block, and
a coupling portion configured to couple the first conductor portion and the second conductor portion,
the second conductor portion has a fifth facing surface facing the first magnetic block and a sixth facing surface facing the second magnetic block, and
a second insulator is disposed between the fifth facing surface and the first magnetic block and between the sixth facing surface and the second magnetic block.

### [Aspect 10]

A DC-DC converter including the inductor according to any one of Aspects 1 to 9.

### REFERENCE SIGNS LIST

1 inductor
2A first magnetic block
2Aa facing surface (third facing surface)
2B second magnetic block
2Ba facing surface (fourth facing surface)
3 coil conductor
4A first conductor portion
4Aa facing surface (first facing surface)
4Ab facing surface (second facing surface)
4B second conductor portion
4Ba facing surface (fifth facing surface)
4Bb facing surface (sixth facing surface)
10A first insulator
10B second insulator
13 adhesive layer
14 insulating layer
100 DC-DC converter

What is claimed is:

1. An inductor comprising:
a first magnetic block and a second magnetic block each having a rectangular parallelepiped shape, the first magnetic block and the second magnetic block being disposed to face each other while being separated from each other in a first direction; and
a coil conductor having a first conductor portion extending in a second direction orthogonal to the first direction,
wherein the first conductor portion is disposed between the first magnetic block and the second magnetic block in the first direction,
the first conductor portion has a first facing surface facing the first magnetic block and a second facing surface facing the second magnetic block,
a first insulator is disposed between the first facing surface and the first magnetic block and between the second facing surface and the second magnetic block, and
a magnetic material disposed between the first magnetic block and the second magnetic block in a region where the coil conductor and the insulator are not disposed is provided.

2. The inductor according to claim 1, wherein the magnetic material is disposed so as to be in contact with the first magnetic block and the second magnetic block.

3. The inductor of claim 1 wherein the insulator includes at least an insulating layer and an adhesive layer.

4. The inductor according to claim 1, wherein at least a part of the first facing surface of the first conductor portion is parallel to a third facing surface of the first magnetic block with respect to the first conductor portion, and
wherein at least a part of the second facing surface of the first conductor portion is parallel to a fourth facing surface of the second magnetic block with respect to the first conductor portion.

5. The inductor according to claim 3, wherein the first conductor portion, the insulating layer, and the adhesive layer are disposed in this order in the first direction.

6. The inductor according to claim 3, wherein the insulating layer further includes a portion covering a surface of the first conductor portion in a third direction orthogonal to the first direction and the second direction.

7. The inductor according to claim 1, wherein the magnetic material has a magnetic permeability of 5 or more.

8. The inductor according to claim 1, wherein the first magnetic block and the second magnetic block are each configured by laminating a plurality of magnetic ribbons, and
a third facing surface of the first magnetic block with respect to the first conductor portion and a fourth facing surface of the second magnetic block with respect to the first conductor portion have an uneven portion.

9. The inductor according to claim 1, wherein the coil conductor further includes
a second conductor portion extending in the second direction and disposed between the first magnetic block and the second magnetic block, and
a coupling portion configured to couple the first conductor portion and the second conductor portion,
the second conductor portion has a fifth facing surface facing the first magnetic block and a sixth facing surface facing the second magnetic block, and
a second insulator is disposed between the fifth facing surface and the first magnetic block and between the sixth facing surface and the second magnetic block.

10. A DC-DC converter comprising the inductor according to claim 1.
